(19) United States
(12) Patent Application Publication
(10) Pub. No.: US 2012/0231207 A1
(43) Pub. Date: Sep. 13, 2012

(54) TEXTILE FABRIC WITH HIGH INSULATION TO WEIGHT RATIO

(76) Inventors: Moshe Rock, Brookline, MA (US); Gadalia Vainer, Melrose, MA (US)

(21) Appl. No.: 13/041,901

(22) Filed: Mar. 7, 2011

(51) Int. Cl. B32B 33/00

(52) U.S. Cl. 428/97

(57) ABSTRACT

A fabric article includes a fabric body having a technical face and a technical back. The fabric body has a raised surface that is formed at one or both of the technical face and the technical back. The raised surface is formed of yarn comprising polyolefin fibers. In some cases, the polyolefin fibers have a delta or trilobal cross-section. The fibers may be hollow. In certain examples, the polyolefin fibers are formed of a polyolefin and a clarifier.

### TECHNICAL FIELD

This disclosure relates to textile fabrics, e.g., velour and/or pile fabrics, having high insulation to weight ratio.

### BACKGROUND

Velour fabric has a short, thick pile that makes the fabric soft to the touch. Velour is often made of wool or cotton, but can also be made from synthetic materials such as polyester and nylon. Generally, velour fabrics made of polyester or nylon exhibit acceptable insulation; however, given the densities of these materials, synthetic velour fabrics can have relatively a relative high weight to insulation ratio.

### SUMMARY

In general, this disclosure relates to textile fabrics, e.g., velour and/or pile fabrics, having high insulation to weight ratio.

In one aspect, a fabric article includes a fabric body having a technical face and a technical back. The fabric body has a raised surface formed at one or both of the technical face and the technical back. The raised surface is formed of yarn that includes polyolefin fibers (e.g., polypropylene fibers, polyethylene fibers, etc.). The polyolefin fibers have a delta or trilobal cross-section.

According to another aspect, a fabric article includes a fabric body having a technical face and a technical back. The fabric body has a raised surface formed at one or both of the technical face and the technical back. The raised surface is formed of yarn that includes polyolefin fibers (e.g., polypropylene fibers, polyethylene fibers, etc.). The polyolefin fibers are formed of a polyolefin and a clarifier.

Implementations may include one or more of the following features. The polyolefin fibers have a hollow core. For example, the polyolefin fibers have a cross-sectional void area of about 5% to about 50%, e.g., about 15% to about 25%, e.g., about 20% to about 25%. The polyolefin fibers are formed of a polyolefin having a density of about 0.93 grams per cubic centimeter (gm/cm³) to about 0.97 grams per cubic centimeter (gm/cm³). The yarn that includes the polyolefin fibers is a fully oriented yarn (FOY). The yarn comprising the polyolefin fibers has a tenacity of about 2.0 grams per denier (gpd) to about 4.0 grams per denier (gpd). The yarn that includes the polyolefin fibers is a textured yarn. Polyolefin fibers can be formed of a polyolefin and a clarifier. The clarifier can be a carboxylic acid salt, such as sodium benzoate or a sorbitol derivative. The clarifier is a trisamide based clarifier.

In another aspect of this disclosure, a fabric article comprises a fabric body having a technical face and a technical back, the fabric body having a raised surface formed at one or both of the technical face and the technical back, the raised surface being formed of yarn comprising nylon fibers and/or polyester fibers, the fibers having a delta or trilobal cross-section.

Implementations of this aspect of the disclosure may have one or more of the following features. The fibers have a hollow core. The fibers have a cross-sectional void area of about 5% to about 50%.

Implementations of both aspects of the fabric article of the disclosure may additionally, or instead, have one or more of the following features. Fibers having a delta cross-sectional shape further define a bump extending axially along one or more side surfaces of the fibers. The fibers have a hollow core, e.g. the fibers have a cross-sectional void area of about 5% to about 50%. The fibers having a delta cross-sectional shape further defining a bump extending along each side surface of the fiber have relatively greater minimum wall thickness about the hollow core, e.g. as compared to polyolefin fibers of similar dimension having delta cross-sectional shape without bumps.

Implementations can include one or more of the following advantages. A velour and/or pile fabric has good thermal insulation at reduced weight, e.g. as compared to conventional velour and/or pile fabrics. Polyolefin fibers are incorporated in a raised surface of a velour and/or pile fabric. The polyolefin fibers are formed in such a manner as to have a pile resiliency (i.e., a resistance to flattening down) that rivals the pile resiliency of other synthetic fibers, such as polyester and nylon fibers, while still exhibiting the relatively light weight characteristic of polyolefins, such as polypropylene and polyethylene. In some cases, the polyolefin fibers are formed with a delta or trilobal cross-section, which helps to provide the fibers with relatively good pile resiliency. Alternatively, or in additional, a clarifier may be added when forming the fibers. The clarifier can provide the resulting fiber with increased resiliency.

Other aspects, features, and advantages are in the description, drawings, and claims.

### DESCRIPTION OF DRAWINGS

FIG. 1 is a schematic end section view of a double-face fabric prebody.

FIG. 2A is a detailed cross-sectional view of a loop yarn formed of polyolefin fibers having a delta cross-sectional shape.

FIG. 2B is a detailed cross-sectional view of a loop yarn formed of polyolefin fibers having a delta cross-section and a hollow core.

FIG. 2C is a detailed cross-sectional view of a polyolefin fiber having a delta cross-section with side-surface bumps and a hollow core, and FIG. 2D is a detailed cross sectional view of a loop yarn formed of such fibers.

FIG. 3 is a schematic view of a melt spinning process.

FIG. 4 is a perspective view of a segment of a circular knitting machine.

FIGS. 5A-5G are sequential views of a cylinder latch needle in a reverse plating circular knitting process.

FIG. 6 is a somewhat diagrammatic perspective view of a double-face velour fabric article.

FIG. 7 is a cross-sectional view of a three-dimensional warp knit fabric structure prior to cutting.

FIG. 8 is a side view illustrating the knitting of a double needle bar fabric.

FIG. 9 is a side view illustrating the splitting of a double needle bar fabric.

FIG. 10 is schematic side view of a napping process.

FIG. 11A is a perspective view of a polyolefin fiber having a trilobal cross-section.

FIG. 11B is a perspective view of a polyolefin fiber having a trilobal cross-section and a hollow core.

Like reference symbols in the various drawings, indicate like elements.

### DETAILED DESCRIPTION

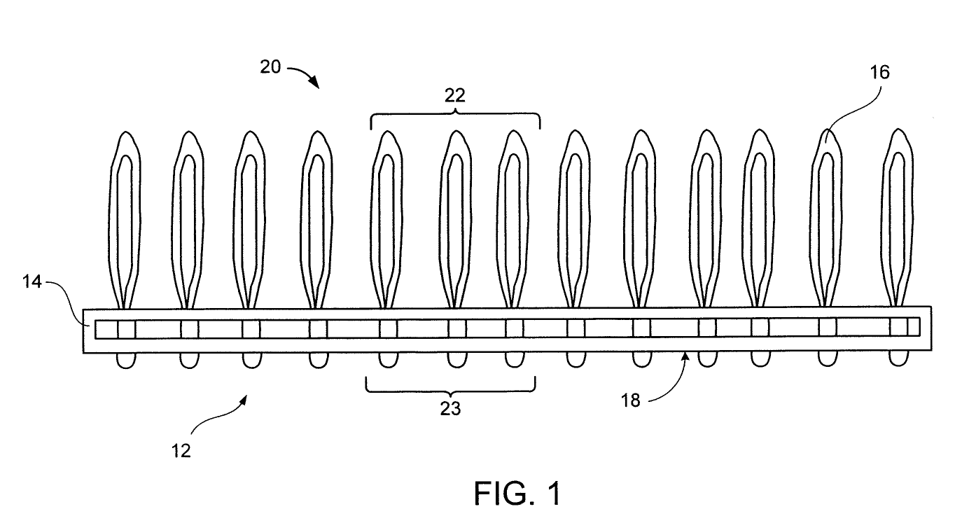

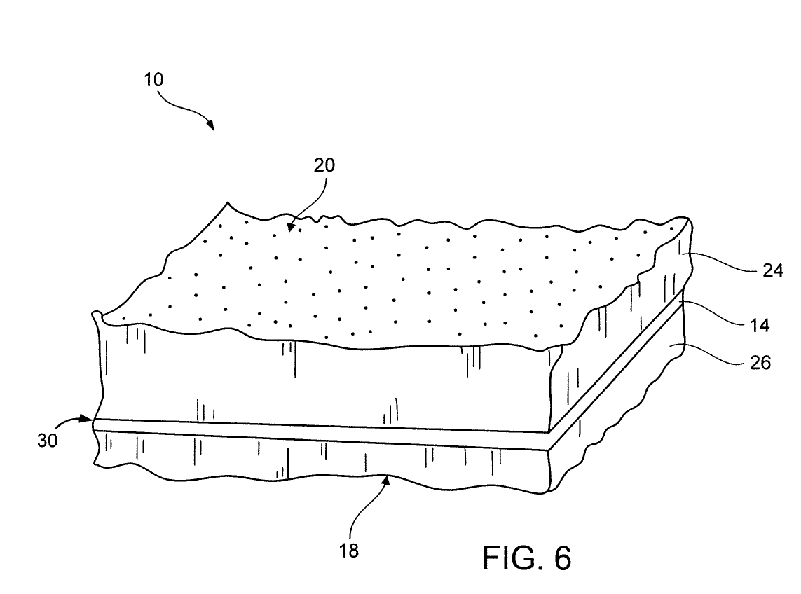

Developing a raised surface (e.g., velour and/or pile) fabric with fibers of polyolefin, e.g., polypropylene, polyethylene, etc., having a relatively low density (e.g., about 0.93 grams per cubic centimeter (gm/cm³) to about 0.97 grams per cubic centimeter (gm/cm³)) can reduce the weight of the fabric significantly as compared to fabrics produced from fibers formed of relatively higher density polymers such as polyester, which has a density of about 1.34 grams per cubic centimeter (gm/cm³), or nylon, which has a density of about 1.15 grams per cubic centimeter (gm/cm³). Polyolefins, such as polypropylene, have a tendency to exhibit lower resiliency than polyester, and, as a result, polyolefin yams incorporated into a velour and/or pile surface can have a tendency to flatten down quite easily, which can be undesirable in terms of aesthetics as well as insulation performance. However, developing a polyolefin yarn formed of fibers having a trilobal or delta cross-section provides the yarn with improve resilience, thus making the yarn more suitable for use in forming a raised (e.g., velour and/or pile) surface. FIG. 1 illustrates a fabric prebody 12 used to form a velour fabric article 10 (FIG. 6). The fabric prebody is formed, e.g., by joining a stitch yarn 14 and a loop yam 16 in a standard reverse plaiting circular knitting (terry knitting) process. In the terry knitting process, the stitch yarn 14 forms the technical face 18 of the resulting fabric prebody 12 and the loop yarn 16 forms the opposite technical back 20, where it is formed into loops 22. In the fabric prebody 12 formed by reverse plaiting circular knitting, the loop yarn 16 extends outwardly to overlie and cover the stitch yarn 14 at the technical face 18.

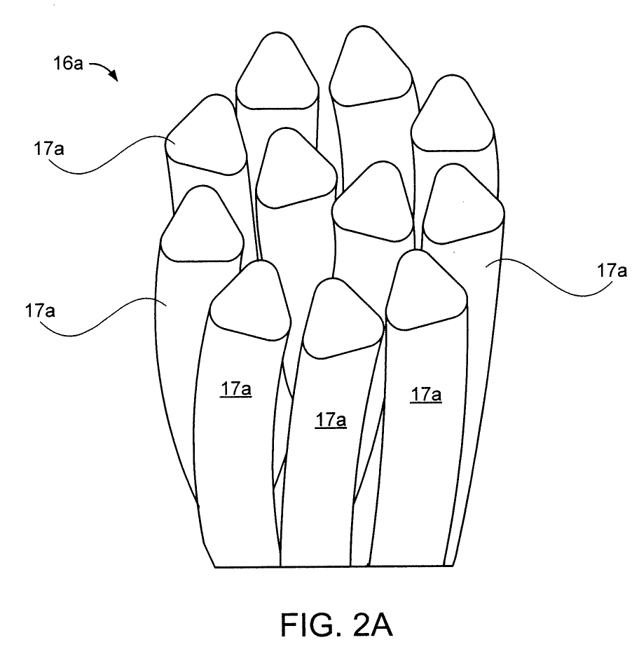

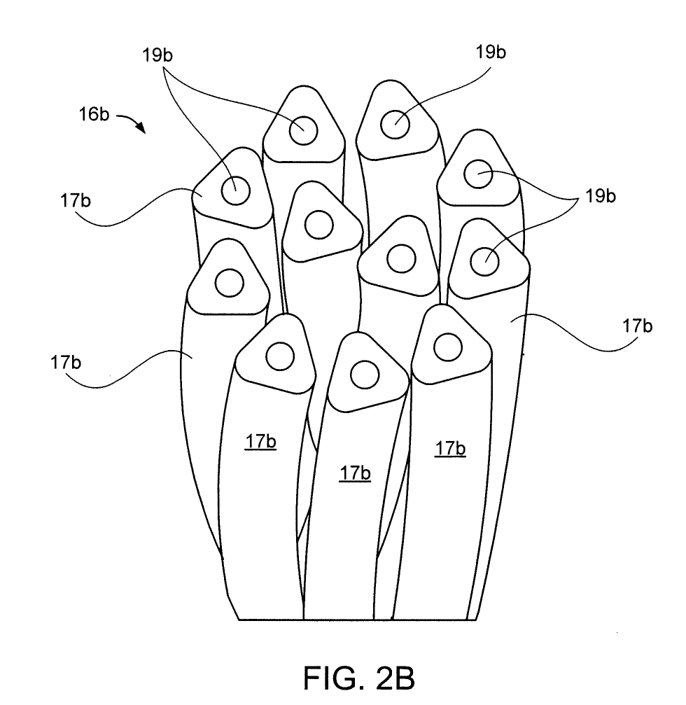

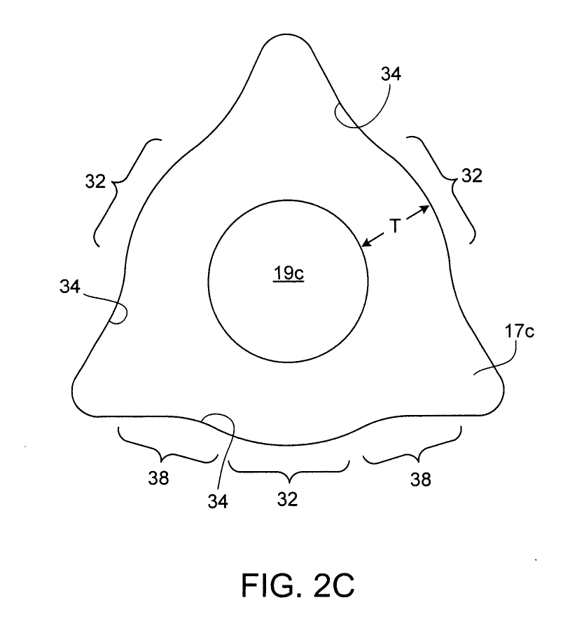

The loop yarn 16 forming the technical back 20 of the fabric body 12 is a spun yarn consisting polyolefin fibers. As illustrated in FIG. 2A, the polyolefin fibers 17a have a delta cross-section. The delta cross-section provides the polyolefin fibers 17a, and, as a result, the loop yarn 16a, with high pile resilience, as compared to standard fibers with round cross-section. As illustrated in FIG. 2B, in some examples, the polyolefin fibers 17b can be formed with a hollow core 19b, which provides for a lighter weight yarn without any significant reduction in bulk. In this regard, the polyolefin fiber 17b can have a cross-sectional void area of 5% to 50% (e.g., 15% to 20% void area). The loop yarn 16b is a fully oriented yarn having tenacity of 2.0 to 4.0 grams per denier, and elongation at break of 40% to 50%. As illustrated in FIGS. 2C and 2D, in some further examples, the polyolefin fibers 17c having a delta cross-section with a hollow core 19c further define a bumps 32 extending axially along one or more side surfaces 34 of the fibers. Fibers 17c with the delta cross-section and side-surface bumps 32 are thought to offer certain advantages, e.g. over the delta cross-sections of FIGS. 2A and 2B. For example, the fibers 17c will diffuse light, which will make the fibers less shiny, less glittery, and less reflective, in particular when viewed in the longitudinal direction, and mainly in fleece/pile fabric. The fibers 17c will add some degree of thickness to the fabric, and the bumps 32 will reduce the “thin wall” effects, i.e. will provide increased wall thickness, T, in the regions of the bumps 32 of the fiber wall surrounding the void 19c, thereby to minimize any fiber weakness and breakage during the fiber/yarn and fabric process, including during finishing/napping. The bumps 32 extending axially between valleys 38 along the sidewall surfaces 34 of the fibers 17c will also assist improvements in water management. Fibers 17c with a delta cross-section and side-surface bumps 32 will also reduce bundling of the fibers while in a fleece/pile form, allowing the fibers 17c to be relatively more easily separated into individual fibers, e.g. as opposed to clumps of fibers, to provide a better cover factor and freer movement of the fibers, resulting in a softer “hand” or feel, with less stiffness. The less bundled fiber pile will also entrap relatively more air, for improved insulation performance (“CLO”—for clothing, a standard measure of thermal insulation) of a raised surface fabric. The fibers 17c may be formed, e.g., of standard polypropylene (tenacity 1.5-3.0 gdp (grams per denier)) or they may be formed of high tenacity polypropylene (3.5-6.0 gpd).

The stitch yarn 14 forming the technical face 16 of the fabric body 12 can also be made of yarn consisting of polyolefin fibers. As in the case of the loop yarn 16, the polyolefin fibers of the stitch yarn 14 can have a delta cross-section. The polyolefin fibers of the stitch yarn 14 may also be formed as hollow-core fibers with a cross-sectional void area of 5% to 50% (e.g., 15% to 20% void area). The stitch yarn 14 is a fully oriented yarn having tenacity of 2.0 to 4.0 gpd, and elongation at break of 40% to 50%.

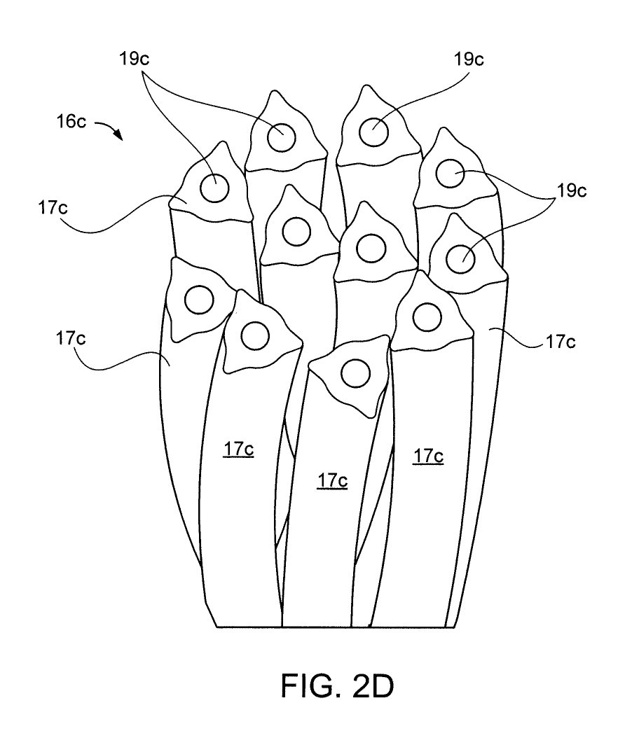

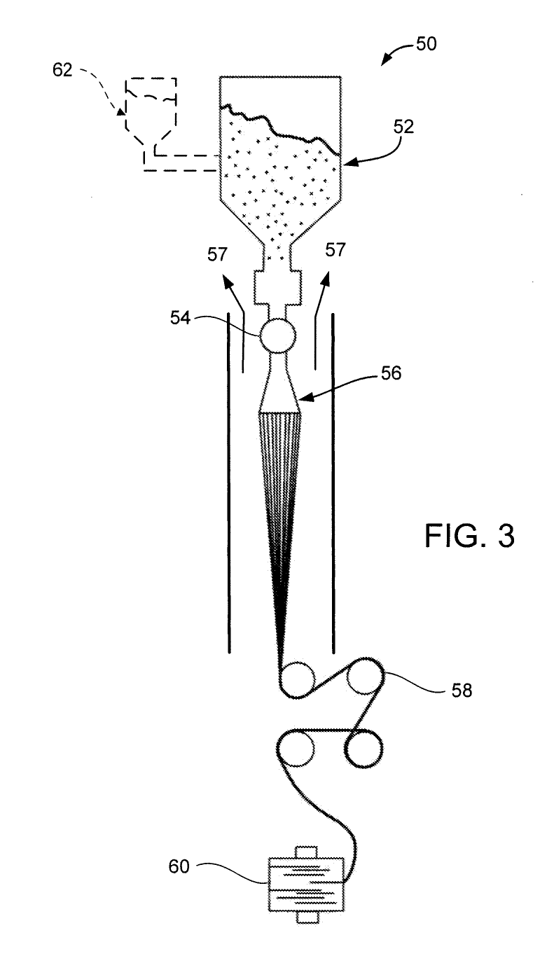

FIG. 3 illustrates a melt spinning process 50 that can be used to form the loop and/or stitch yarns 14, 16. A source 52 of polyolefin (e.g., polypropylene, polyethylene) having a density of about 0.93 grams per cubic centimeter (gm/cm³) to about 0.97 grams per cubic centimeter (gm/cm³) is heated, and is then fed, in a molten state, via a pump 54 toward a spinneret 56. The spinneret defines fine orifices, through which the molten polyolefin is extruded (at a controlled rate) into a flow of air or other gas 57, where it is cooled and solidified. To form the delta cross-section, the orifices of the spinneret 56 have a delta shape. In some implementations, a hollow-fiber spinneret is used to form hollow-core fibers. The solidified filaments are drawn-off by rotating rolls 58, and wound onto bobbins 60.

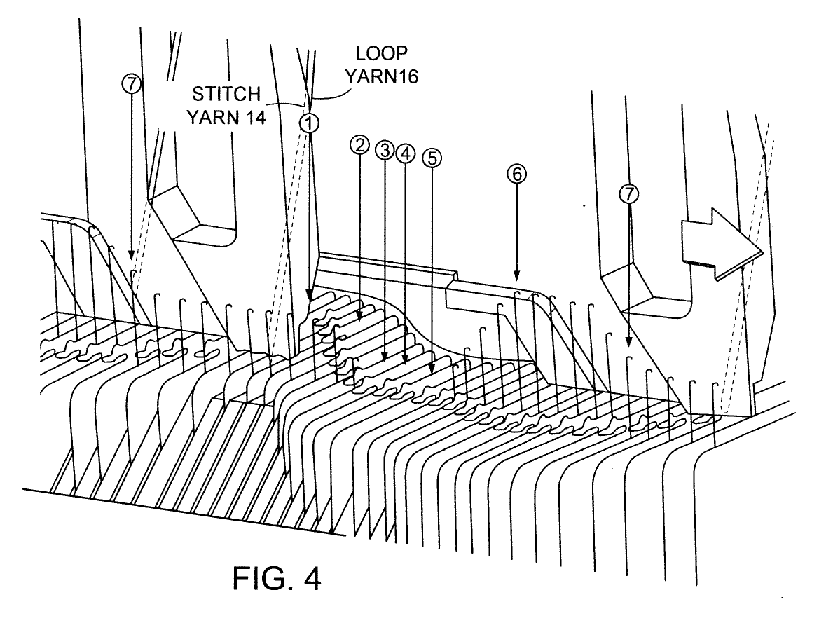

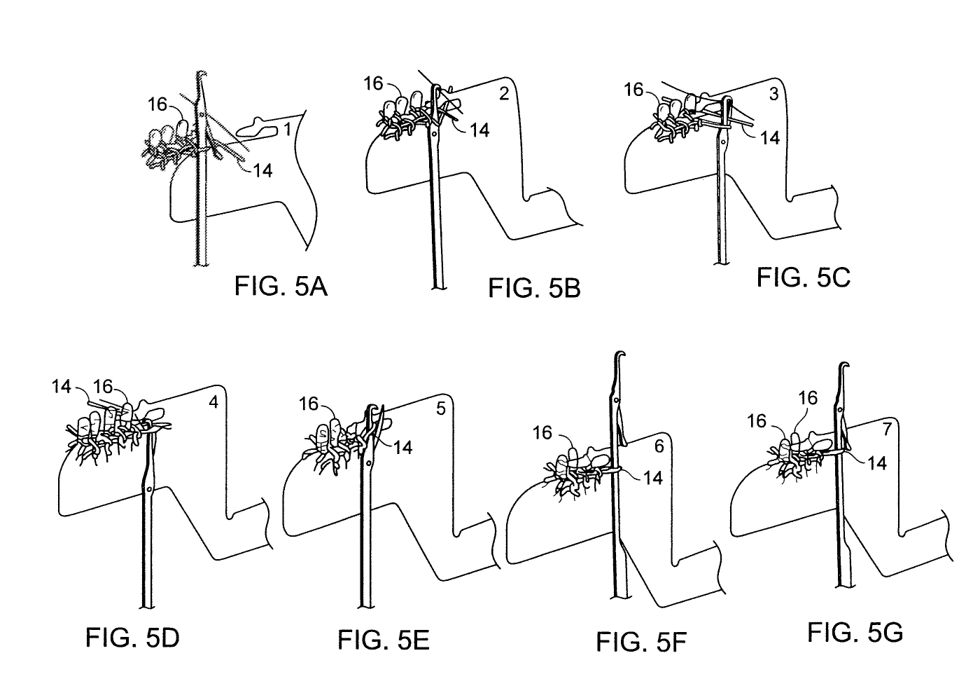

In some implementations, one or more additives can be introduced into the molten polyolefin, e.g., from an additive source 62. The one or more additives can include clarifiers such as carboxylic acid salts (e.g., sodium benzoate, sorbitol derivative, etc.) or trisamide based clarifier. The addition of a clarifier can provide for improved physical properties, such as stiffness, tenacity, reduced elongation, etc., while maintaining the low density of the polyolefin. The addition of such a clarifier can also allow fibers, with adequate resiliency, to be formed in a broader variety of cross-sectional shapes (e.g., round, delta, trilobal, delta with hollow core, etc.). Referring to FIGS. 4 and 5A-5G, the fabric prebody is formed (in a continuous web) by joining the stitch yarn 14 and the loop yarn 16 in a standard reverse plating circular knitting (terry knitting) process. This is principally a terry knit construction, where segments 23 of the loop yarn 16 cover the stitch yarn 14 on the technical face 18 and loops 22 of the loop yarn 16 form loops 22 at the technical back 20 of the fabric prebody 12.

The fabric prebody 12 is next subjected to finishing. During the finishing process, the technical face and technical back surfaces 18, 20, respectively, of the fabric prebody 12, with the segments 23 of loop yarn 16 overlying the stitch yarn 14 at the technical face surface 18 and the loops 22 formed at the technical back surface 20, are subjected to a finishing process, e.g., such as sanding, brushing and/or napping, to generate a velour 24, 26. The yarn fibers are raised at one or both surfaces of the fabric prebody 12, including the technical face 18 and/or the technical back 20, to form the velour 24, 26 at each face of the fabric body 30 of the double-face velour fabric article 10 (FIG. 6). The resulting fabric article 10 is of relatively light weight, due to the use of relatively low density (e.g., about 0.93 grams per cubic centimeter (gm/cm³) to about 0.97 grams per cubic centimeter (gm/cm³) polyolefin, and has a raised surface (e.g., velour/pile) with sufficient resiliency due to the fiber cross-section and/or the incorporation of a clarifier.

### Other Implementations

While certain implementations have been described above, other implementations are possible.

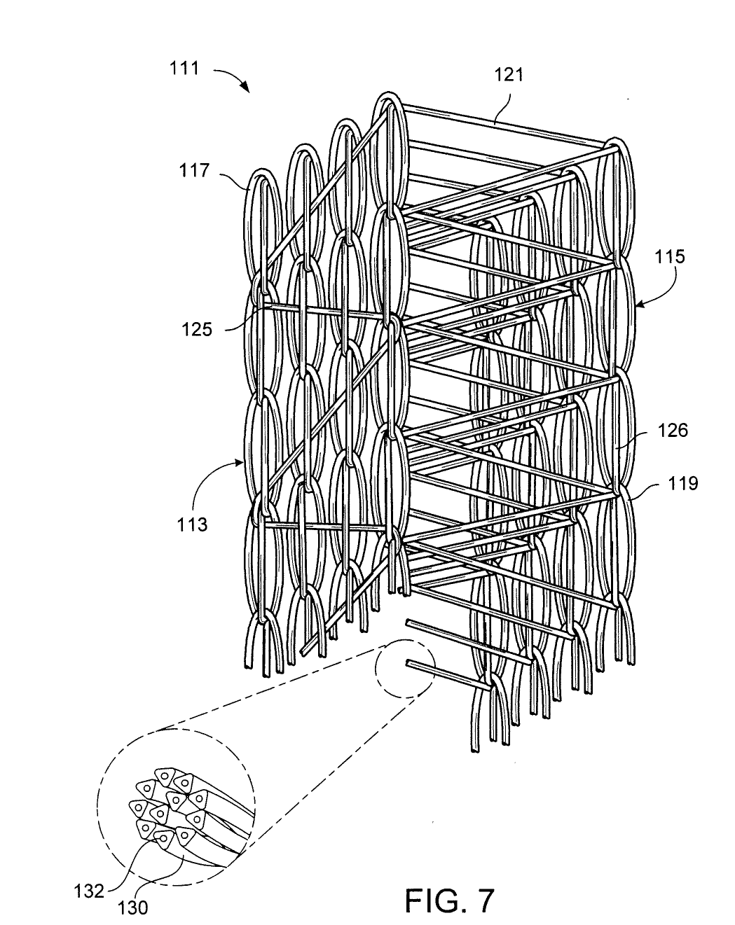

As an example, while an implementation has been described in which both the loop yarn and/or the stitch yarn consist of a yarn that includes polyolefin fibers, in some embodiments only the loop yarn or only the stitch yarn includes such polyolefin fibers. While a circular knit velour fabric article has been described, in some implementations the raised surface fabric can instead have warp knit construction (e.g., formed using a double bar needle warp knitting machine). For example, as shown in FIG. 7, a three dimensional knit fabric is generally indicated at 111 and includes a first fabric layer 113 made from stitch yarn 117, a second fabric layer 115 made from stitch yarn 119, and pile yarn 121 interconnecting the two layers. In addition, knit fabric 111 includes backing yarn 125 and 126 that is knit into stitch yarn 117 and 119 respectively. Among the various yarns 117, 119, 121, 125, and 126, at least the pile yarns 121 are formed of polyolefin fibers 130 having a delta cross-section. The polyolefin fibers may optionally include a hollow core 132, which provides for a lighter weight yarn without any significant reduction in bulk. In this regard, the polyolefin fiber 130 can have a cross-sectional void area of 5% to 50% (e.g., 15% to 20% void area).

As in the case of the reverse plaited circular knit fabric described above, the use of relatively low density polyolefin (e.g., polypropylene, polyethylene, etc.) to form the fibers 130 can help to reduce the overall weight of the fabric 111. In addition, using fibers 130 with a delta cross-section provides the yarns with good pile resilience.

The pile yarn 121 is a fully oriented yarn having tenacity of 2.0 to 4.0 grams per denier, and elongation at break of 40% to 50%.

As can be appreciated from FIG. 7, pile yarn 121 is plaited at one end around stitch yarn 119 and at the other end around stitch yarn 117. This plaited construction facilitates the napping process, as described below.

In some cases, the bulk of the pile yarn 121 can be greater than that of stitch yarn 117 and 119. The bulk of the yarn is a measurement of the effective cross section of the yarn and is a yarn characteristic well known in the art.

A higher bulk ratio of pile yam/stitch yarn can help to enhance nappability, and can also help to reduce damage and/or breakage of the stitch yarn during napping. In some cases, the fabric 111 has a bulk ratio of about 1.0:1 to about 3:1.

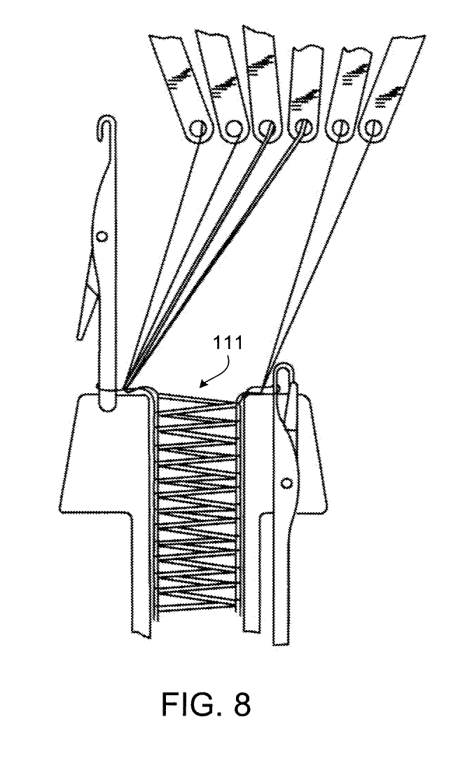

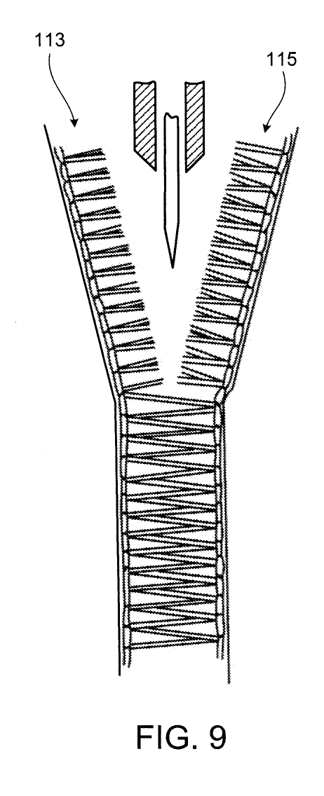

After producing the three dimensional knit, the yarn connecting the two surfaces is cut with a splitter (FIGS. 8 and 9) to form two intermediate fabrics 113 and 115 with a velvet on the technical face and a flat surface or jersey on the technical back that is treated to form a fleece as described below.

Each intermediate fabric is formed of a base or substrate defined by the stitch yarns 117 or 119, backing yarns 125, 126, and the pile yarns 121, as shown in FIG. 7.

Now the fabric is ready to be finished on the technical back or jersey side. For this purpose, a standard napper can be used. Such nappers are well known in the art of manufacturing textile fabrics. Presently-available nappers are made with precise control mechanisms to adjust, not only the cylinder speed and pressure, but also the fabric speed and tension.

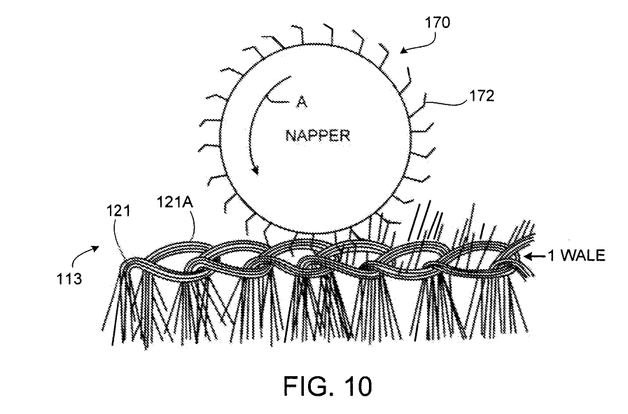

Referring to FIG. 10, a fabric is being shown being napped by a napper graphically represented by a cylinder 170. Cylinder 170 is rotating in the direction indicated by arrow, A, and is provided with a plurality of angled fingers 172. As can be seen in FIG. 10, the direction of rotation of cylinder 170 and the orientation of wires 172 is such that the fabric 113 is napped in the direction of the loops 121A of the pile yarns 121. (In FIG. 10 the substrate has been omitted for the sake of clarity).

Additional features and/or steps combinable with the double needle bar knit fabric and/or the double needle bar knitting process discussed above are described in U.S. Pat. Nos. 6,196,032; 6,199,410; 6,832,497; 6,837,078; and 5,855,125, the entire contents of each of which are incorporated herein by reference.

Referring again to FIG. 1, surfaces of the fabric article of the disclosure may also be mechanically finished in a cut loop process, where a reverse plaited fabric construction 20 having a technical face 18 and a technical back 20, and having the loop yarn 16 plaited around stitch yarn 14 (FIG. 4) in order to define a plurality of single loops on the technical back, wherein only the technical face of the fabric construction has a surface that is raised, and the technical back of the fabric has a surface upon which the loops are 22 sheared without raising the surface of the technical back. The terry sinker loops 22 may be sheared after the fabric is removed from the knitting machine, or, in the alternative, the loops may be cut by a knife or blade directly on the knitting machine. The cut loop process is described, e.g., in U.S. Pat. No. 6,131,419, the complete disclosure of which is incorporated herein by reference.

Still other fabric constructions are also possible. For example, in some cases, the polyolefin yarns can be incorporated into a raised surface of a circular knit construction with regular plaiting, in which a technical face of the fabric is made of a stitch yarn overlay (or cover).

In some cases, the fabric including the polyolefin yarns can include one or more raised surfaces in the form of a pattern, such as grid, box, etc., selected to generate a channeling effect, e.g. as described in U.S. application Ser. No. 10/047,939, filed Oct. 23, 2001, now U.S. Pat. No. 6,927,182, issued Aug. 9, 2005 the complete disclosure of which is incorporated herein by reference.

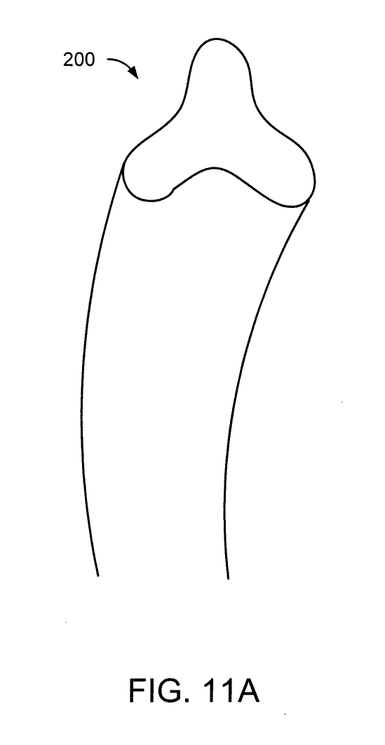

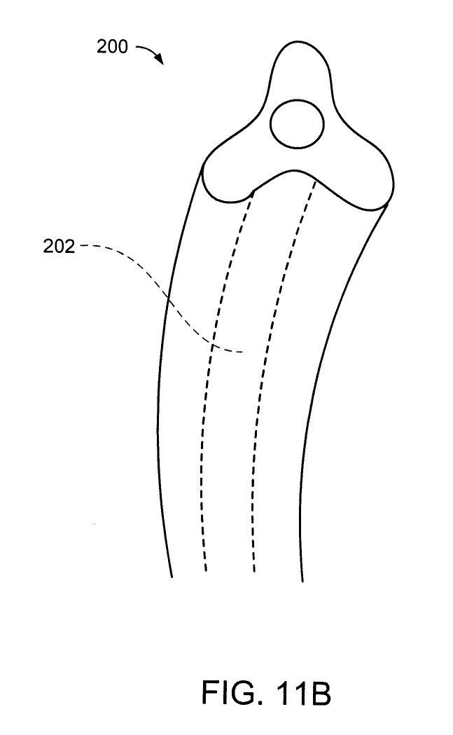

Although implementations have been described in which polyolefin fibers have a delta cross-section, in some implementations the fiber can have a trilobal cross-section. FIG. 11A illustrates a polyolefin fiber 200 that has a trilobal cross-section, which can be incorporated into a yarn. As shown in FIG. 11B, in some cases, the trilobal polyolefin fiber 200 can have a hollow core 202, which provides for a lighter weight fiber without any significant reduction in bulk. In this regard, the polyolefin fiber 200 can have a cross-sectional void area of 5% to 50% (e.g., 15% to 20% void area). The trilobal polyolefin fiber 202 can be formed by incorporating a spinneret with trilobal shaped orifices in the melt spinning process of FIG. 3.

Furthermore, the incorporation of a clarifier into the polyolefin fibers can help to improve the physical properties of the polyolefin such that polyolefin fibers having other cross-sectional shapes (e.g., round), and exhibiting sufficient pile resilience for use in forming a velour or pile surface, are also possible.

In some implementations, the polyolefin yarns (i.e., yarns formed of polyolefin fibers) can be textured. In one example, a textured yarn is formed of hollow core, polyolefin fibers having delta and/or trilobal cross-section with a void area of 20% to 25%.

The polyolefin yarn can be in multi-filament fiber or spun yarn made of staple fibers.

The loop yarn 16 forming the technical back 20, and/or the stitch yarn 14 of the technical face 18 of the fabric body 12 may be a spun yarn consisting, e.g., of nylon or polyester fibers having a delta or trilobal cross-section. The nylon or polyester fibers may also have a solid core, or a hollow core having a cross-sectional void area of about 5% to about 50%. Nylon has a density of about 1.15 grams per cubic centimeter (gm/cm³), which is relatively higher than the density of polyolefin, e.g. polypropylene, polyester, etc., (e.g., about 0.94 to 0.97 grams per cubic centimeter (gm/cm³)). Polyester has a somewhat higher density (e.g., about 1.34 grams per cubic centimeter (gm/cm³). Other implementations are within the scope of the following claims.

What is claimed is:

1. A fabric article comprising:
a fabric body having a technical face and a technical back, the fabric body having a raised surface formed at one or both of the technical face and the technical back,
wherein the raised surface is formed of yarn comprising polyolefin fibers, and the polyolefin fibers have a delta or trilobal cross-section.

2. The fabric article of claim 1, wherein the polyolefin fibers have a hollow core.

3. The fabric article of claim 2, wherein the polyolefin fibers have a cross-sectional void area of about 5% to about 50%.

4. The fabric article of claim 3, wherein the polyolefin fibers have a cross-sectional void area of about 15% to about 25%.

5. The fabric article of claim 4, wherein the polyolefin fibers have a cross-sectional void area of about 20% to about 25%.

6. The fabric article of claim 1, wherein the polyolefin fibers are formed of a polyolefin having a density of about 0.93 grams per cubic centimeter (gm/cm³) to about 0.97 grams per cubic centimeter (gm/cm³).

7. The fabric article of claim 6, wherein the polyolefin fibers are formed of a polyolefin having a density of about 0.93 grams per cubic centimeter (gm/cm³).

8. The fabric article of claim 1, wherein the yarn comprising the polyolefin fibers is a fully oriented yarn (FOY).

9. The fabric article of claim 8, wherein the yarn comprising the polyolefin fibers has a tenacity of about 2.0 grams per denier (gpd) to about 4.0 grams per denier (gpd).

10. The fabric article of claim 1, wherein the yarn comprising the polyolefin fibers is a textured yarn.

11. The fabric article of claim 1, wherein polyolefin fibers are formed of a polyolefin and a clarifier.

12. The fabric article of claim 11, wherein the clarifier is a carboxylic acid salt.

13. The fabric article of claim 12, wherein the carboxylic acid salt is sodium benzoate or a sorbitol derivative.

14. The fabric article of claim 11, wherein the clarifier is a trisamide based clarifier.

15. The fabric article of claim 1, wherein the polyolefin fibers are formed of a polyolefin selected from the group consisting of polypropylene and polyethylene.

16. The fabric article of claim 1, wherein the polyolefin fibers having a delta cross-sectional shape further define a bump extending axially along one or more side surfaces of the fibers.

17. The fabric article of claim 16, wherein the polyolefin fibers have a hollow core.

18. The fabric article of claim 17, wherein the polyolefin fibers have a cross-sectional void area of about 5% to about 50%.

19. The fabric article of claim 17, wherein the polyolefin fibers having a delta cross-sectional shape further defining a bump extending along each side surface of the fiber have relatively greater minimum wall thickness about the hollow core, as compared to polyolefin fibers having delta cross-sectional shape without bumps.

20. A fabric article comprising:
a fabric body having a technical face and a technical back, the fabric body having a raised surface formed at one or both of the technical face and the technical back,
wherein the raised surface is formed of yarn comprising polyolefin fibers, and the polyolefin fibers are formed of a polyolefin and a clarifier.

21. The fabric article of claim 20, wherein the polyolefin fibers have a hollow core.

22. The fabric article of claim 21, wherein the polyolefin fibers have a cross-sectional void area of about 5% to about 50%.

23. The fabric article of claim 22, wherein the polyolefin fibers have a cross-sectional void area of about 15% to about 25%.

24. The fabric article of claim 23, wherein the polyolefin fibers have a cross-sectional void area of about 20% to about 25%.

25. The fabric article of claim 20, wherein the polyolefin fibers are formed of a polyolefin having a density of about 0.93 grams per cubic centimeter (gm/cm³) to about 0.97 grams per cubic centimeter (gm/cm³).

26. The fabric article of claim 25, wherein the polyolefin fibers are formed of a polyolefin having a density of about 0.93 grams per cubic centimeter (gm/cm³).

27. The fabric article of claim 20, wherein the yarn comprising the polyolefin fibers is a fully oriented yarn (FOY).

28. The fabric article of claim 27, wherein the yarn comprising the polyolefin fibers has a tenacity of about 2.0 grams per denier (gpd) to about 4.0 grams per denier (gpd).

29. The fabric article of claim 20, wherein the yarn comprising the polyolefin fibers is a textured yarn.

30. The fabric article of claim 20, wherein the clarifier is a carboxylic acid salt.

31. The fabric article of claim 30, wherein the carboxylic acid salt is sodium benzoate or a sorbitol derivative.

32. The fabric article of claim 20, wherein the clarifier is a trisamide based clarifier.

33. The fabric article of claim 20, wherein the polyolefin is selected from the group consisting of polypropylene and polyethylene.

34. The fabric article of claim 20, wherein the polyolefin fibers have a cross-sectional shape selected from the group consisting of round, delta, and trilobal.

35. The fabric article of claim 34, wherein the polyolefin fibers having a delta cross-sectional shape further define a bump extending axially along one or more side surfaces of the fibers.

36. The fabric article of claim 35, wherein the polyolefin fibers have a hollow core.

37. The fabric article of claim 36, wherein the polyolefin fibers have a cross-sectional void area of about 5% to about 50%.

38. The fabric article of claim 36, wherein the polyolefin fibers having a delta cross-sectional shape further defining a bump extending along each side surface of the fiber have relatively greater minimum wall thickness about the hollow core, as compared to polyolefin fibers of similar dimension having delta cross-sectional shape without bumps.

39. A fabric article comprising:
a fabric body having a technical face and a technical back,
the fabric body having a raised surface formed at one or both of the technical face and the technical back,
wherein the raised surface is formed of yarn comprising nylon fibers, and the nylon fibers have a delta or trilobal cross-section.

40. The fabric article of claim 39, wherein the nylon fibers have a hollow core.

41. The fabric article of claim 40, wherein the nylon fibers have a cross-sectional void area of about 5% to about 50%.

42. A fabric article comprising:
a fabric body having a technical face and a technical back, the fabric body having a raised surface formed at one or both of the technical face and the technical back,
wherein the raised surface is formed of yarn comprising polyester fibers, and the polyester fibers have a delta or trilobal cross-section.

43. The fabric article of claim 42, wherein the polyester fibers have a hollow core.

44. The fabric article of claim 43, wherein the polyester fibers have a cross-sectional void area of about 5% to about 50%.

45. The fabric article of claim 42, wherein the polyester fibers having a delta cross-sectional shape further define a bump extending axially along one or more side surfaces of the fibers.
